(19) United States
(12) Patent Application Publication
(10) Pub. No.: US 2012/0009088 A1
(43) Pub. Date: Jan. 12, 2012

(54) HIGH-PERFORMANCE LIGHT SOURCE APPARATUS FOR FLUORESCENCE PHOTOGRAPHY

(76) Inventors: Shuo-Ting Yan, Hsin-Chu (TW); Wei-Li Hong, Hsin-Chu (TW); Yuan Yu Tsai, Hsin-Chu (TW)

(21) Appl. No.: 12/961,215

(22) Filed: Dec. 6, 2010

(30) Foreign Application Priority Data
Jul. 9, 2010 (TW) 099122656

(51) Int. Cl. G01N 21/64

(52) U.S. Cl. 422/82.08

(57) ABSTRACT

A high-performance light source apparatus for fluorescence photography of biomolecule sample gels is disclosed. The high-performance light source apparatus comprises a base frame, a supporting region located on the center of the top surface of the base frame for supporting a biomolecule sample gel, and at least one light-emitting module disposed on the top surface of the base frame around the supporting region for emitting an exciting light onto the biomolecule sample gel laterally. Each light-emitting module comprises an LED array having different colors of LEDs for different bio reagents. The exciting light is projected onto the biomolecule sample gel laterally, such that the size of the high-performance light source apparatus can be minimized, and the light spots interference in fluorescence photographing or observation can be prevented.

### BACKGROUND OF THE INVENTION

The present invention relates to a light source apparatus for fluorescence photography, and more particularly to a high-performance light source apparatus for fluorescence photography of biomolecule sample gels.

In biotechnology experiments, to all eukaryotes, protein phosphorylation can cause the organism to change the activation of the intracellular protein or enzyme, transmit signal, or regulate cell physiological processes such as cell metabolism, cell growth, cell proliferation or cell cancerization. However, the content of phosphorylated proteins in organism is extremely low and normally kept in a dynamic balance status. It is difficult to detect or analyze the phosphorylated proteins before applying a pre-concentration process.

Western blotting was introduced by Towbin et. al. in 1979 and is now a routine technique for protein analysis. The specificity of the antibody-antigen interaction enables a target protein to be identified in the midst of a complex protein mixture. The biomolecule sample that is separated by gel electrophoresis is labeled with an enzyme or fluorescent dye for qualitative or quantitative analysis.

According to the characteristics of biomolecule samples, different bio reagents or fluorescent dyes are used to label the biomolecule samples. After sample labeling, the method for observation is also different. For example, in a DNA fluorescence image observation, a 465 nm blue LED-based backlight is used to excite the labeled DNA sample to fluoresce, and then an optical lens and a CCD camera are used for observation or photographing.

FIG. 1 illustrates a conventional fluorescence photographing apparatus. As illustrated, the fluorescence photographing apparatus 10 comprises a photography module 12, an amber filter 141 and a light source module 18.

The light source module 18 comprises a housing 181 having a top opening, a blue filter 187 mounted in the top opening of the housing 181 and a blue LED array 183 disposed in the housing 181 below the top opening. The DNA sample gel 16 that completes the electrophoresis can be placed on the blue filter 187 for observation.

The blue LED array 183 provides a blue light source for exciting the sample. The blue filter 187 allows only blue light with 465 nm wavelength to pass. The DNA in the DNA sample gel 16 is excited to fluoresce and is able to be observed or photographed by means of the photography module 12.

To enhance the contrast of the image, an amber filter 141 is disposed between the photography module 12 and the DNA sample gel 16 to remove the blue light of the back light source. Further, in order to prevent light spots of the LED light source from interfering in the image, a diffuser 185 is disposed between the blue LED array 183 and the blue filter 187 for diffusing each light spot into a uniform light in a larger area.

The aforesaid prior art fluorescence photography apparatus is workable for fluorescence photographing and observation. However, due to the limitation of the structure, one apparatus is suitable for exciting light source with single wavelength. Furthermore, the diffuser 185 in the light source module 18 will reduce the intensity of the exciting light source and increase the energy consumption.

The aforesaid light source module 18 is a trans-illuminator. An epi-illuminator type light source module may be used in a fluorescence photographing apparatus, as shown in FIG. 2.

As illustrated in FIG. 2, the fluorescence photographing apparatus 20 comprises a photography module 22, an amber filter 24 and a light source module 26.

The light source module 26 comprises a housing 269 having a top opening 261; a black lining 265 disposed on the bottom. The DNA sample gel 28 is disposed on the black lining 265 for observation.

The light source module 26 comprises blue LED arrays 263 disposed inside the housing 269 out of the range of the top opening 261 and adapted for emitting blue light obliquely downwardly onto the DNA sample gel 28 for exciting the DNA sample gel 28 to fluoresce.

According to this design of the fluorescence photographing apparatus 20, the blue LED arrays 263 emit light obliquely downwardly onto the DNA gel 28, and the black lining 265 absorbs stray light, therefore this design prevents light spot from interference during photographing or sample observation. Further, by using an amber filter 24 to remove blue light, the contrast of the image can be enhanced.

However, in order to illuminate uniformly on the DNA sample gel 28, and taking the distance between the light source and the DNA sample gel 28 into consideration, the blue LED arrays 263 should comprises a plurality of rows of blue LEDs and the blue LEDs should be arranged densely to obtain a better illuminating effect. Further, due to the limitation of the structure, there must be a lot of ineffective illumination area 267 inside the housing 269. In consequence, the manufacturing cost is high, and much energy will be wasted during application.

Furthermore, the mechanisms and illumination principle employed in the aforesaid two prior art fluorescence photographing apparatuses require a long distance between the blue LED array and the DNA sample gel to obtain a uniform illumination, in consequence, the size of the apparatus will be quite big.

### SUMMARY OF THE PRESENT INVENTION

It is one objective of the present invention to provide a high-performance light source apparatus for fluorescence photography, and more particularly to a high-performance light source apparatus for the fluorescence photography of biomolecule sample gels.

It is another objective of the present invention to provide a high-performance light source apparatus for fluorescence photography, which emits an exciting light onto the biomolecule sample gel laterally for preventing light spot interference without diffuser.

It is still another objective of the present invention to provide a high-performance light source apparatus for fluorescence photography, which uses one-dimensional LED array for each light-emitting module, such that the manufacturing cost is reduced and the size of the apparatus is minimized.

It is still another objective of the present invention to provide a high-performance light source apparatus for fluorescence photography, wherein each LED array comprises a plurality of LEDs in a plurality of colors for providing different colors of exciting light for different applications.

It is still another objective of the present invention to provide a high-performance light source apparatus for fluorescence photography, which comprises a controller coupled to each LED array for controlling the on/off of each color of LEDs.

It is still another objective of the present invention to provide a high-performance light source apparatus for fluorescence photography, wherein the controller is capable of controlling the brightness of the LEDs that are turned on.

It is still another objective of the present invention to provide a high-performance light source apparatus for fluorescence photography, which utilizes a condenser to condense or collimate the exciting light onto the biomolecule sample gel for enhancing the energy efficiency.

It is still another objective of the present invention to provide a high-performance light source apparatus for fluorescence photography, wherein the condenser comprises a micro-prismatic structure for condensing or collimating the exciting light.

The present invention provides a high-performance light source apparatus for fluorescence photography, comprising: a base frame having a top surface; a supporting region located on the center area of the top surface for supporting a biomolecule sample gel; and at least one light-emitting module disposed on the top surface around the border area for projecting an exciting light laterally onto the biomolecule sample gel.

### BRIEF DESCRIPTION OF THE DRAWINGS

FIG. 1 is a schematic cross-sectional view of a fluorescence photographing apparatus in accordance with a prior art.

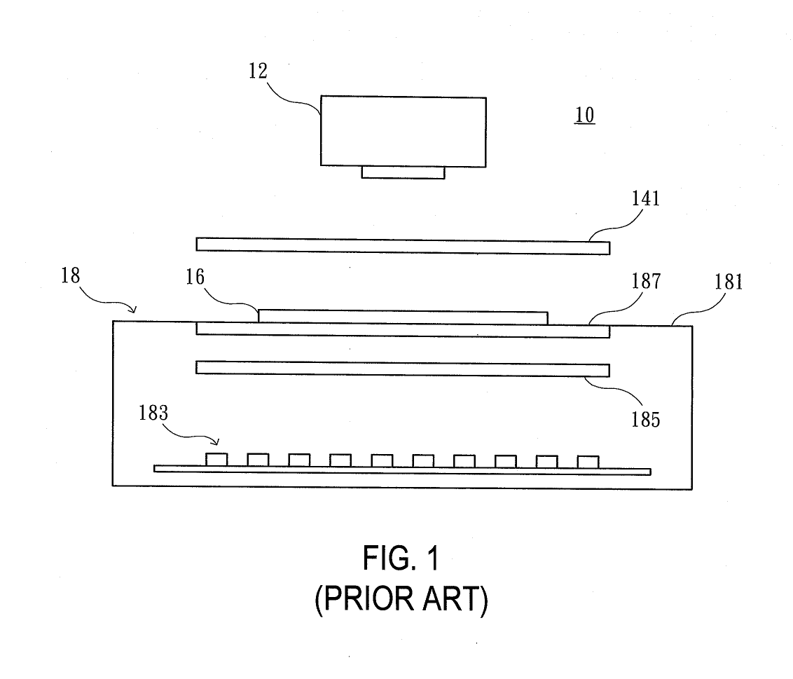

FIG. 2 is a schematic cross-sectional view of another fluorescence photographing apparatus in accordance with a prior art.

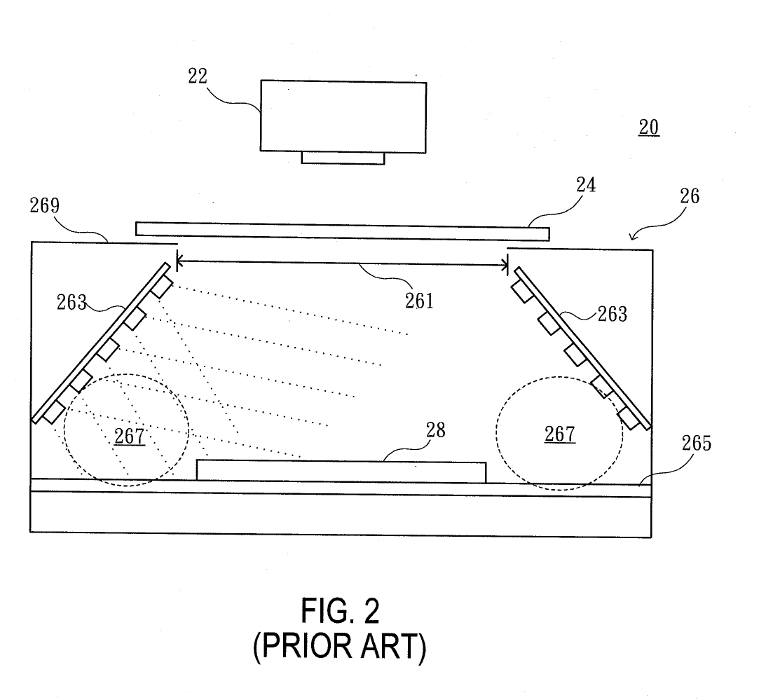

FIG. 3 is a schematic cross-sectional view of a high-performance light source apparatus for fluorescence photography in accordance with one embodiment of the present invention.

FIG. 4 is a longitudinal sectional view of a light-emitting module of the high-performance light source apparatus for fluorescence photography in accordance with one embodiment of the present invention.

FIG. 5 is a transverse sectional view of a light-emitting module of the high-performance light source apparatus for fluorescence photography in accordance with one embodiment of the present invention.

### DETAILED DESCRIPTION OF THE PREFERRED EMBODIMENTS

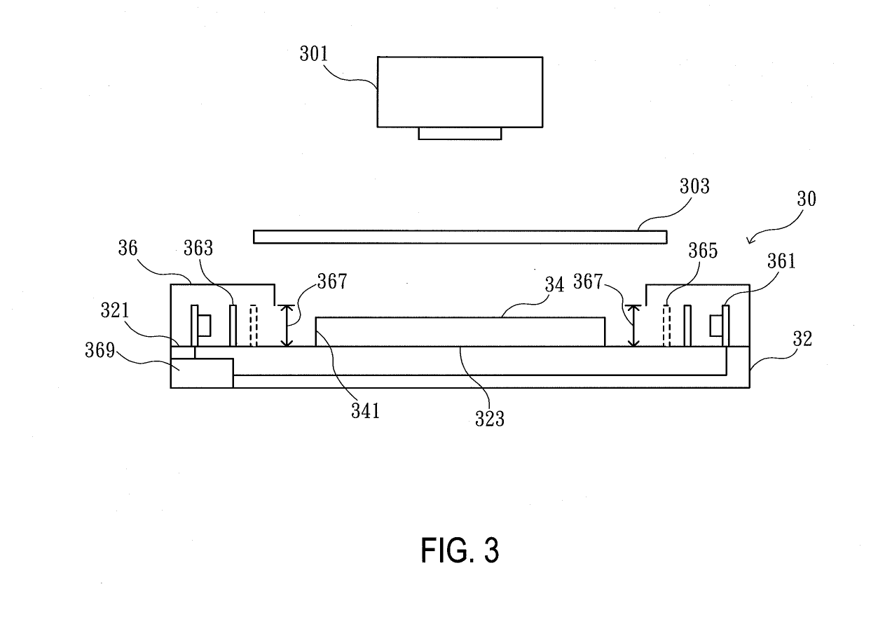

Referring to FIG. 3, there is shown a high-performance light source apparatus 30 for fluorescence photography in accordance with one embodiment of the present invention. The high-performance light source apparatus 30 comprising a base frame 32, a supporting region 323 and at least one light-emitting module 36.

The supporting region 323 is located on the center area of the top surface 321 of the base frame 32. The at least one light-emitting module 36 is disposed on the top surface 321 of the base frame 32 around the border area, and adapted for emitting exciting light to excite a biomolecule sample gel 34 on the supporting region 323. The exciting light is projected onto to the biomolecule sample gel 34 laterally for preventing the light spots from interfering in fluorescence photographing or observation.

If the base frame 32 has a circular configuration, one single light-emitting module 36 that is annularly configured is disposed around the circular border area of the top surface 321 of the base frame 32. If the base frame 32 has a rectangular configuration, two light-emitting modules 36 can be disposed on the border area of the top surface 321 of the base frame 32 at two opposite sides, or alternatively, four light-emitting modules 36 can be respectively arranged on the top surface 321 of the base frame 32 at the four sides.

Each light-emitting module 36 comprises an LED array 361, and a light-emitting port 367 located at the side adjacent to the supporting region 323. The light-emitting port 367 can be an opening of the light-emitting module 36 or a transparent plate made of glass or acrylic attached to the light-emitting module 36, so that it allows different colors of exciting light or ultraviolet light to pass through and illuminates the biomolecule sample gel 34 directly. Therefore, the high-performance light source apparatus 30 is suitable for different types of biomolecule samples and enzyme or fluorescent dye. Since the exciting light can be absorbed by the biomolecule sample gel 34 directly without diffusion and filtration, the efficiency is improved.

As the high-performance light source apparatus 30 illuminates the exciting light onto the biomolecule sample gel 34 laterally and the biomolecule sample gel 34 simply has a limited thickness, one-dimensional LED arrays is sufficient to achieve a satisfactory exciting light illumination.

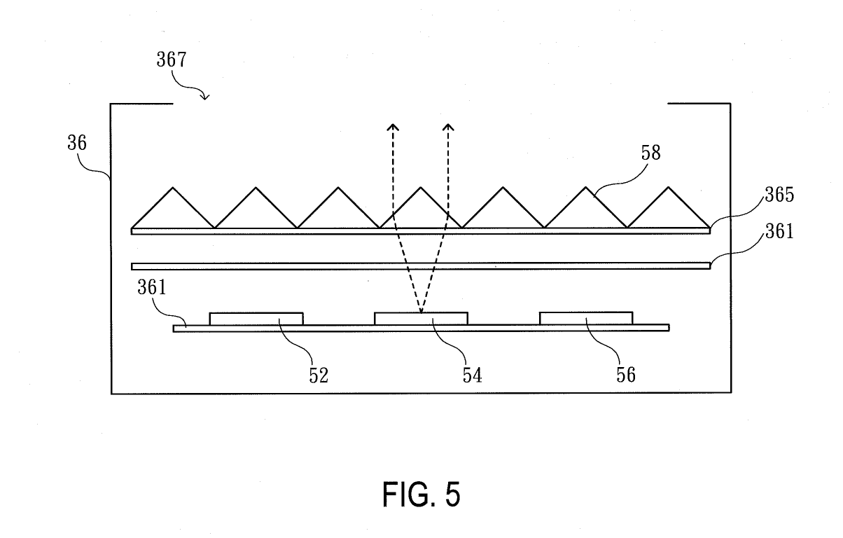

The one dimensional LED array 361 can comprise LEDs of one single color for one single application. Alternatively, the one dimensional LED array 361 can comprise LEDs of different colors, for example, as shown in FIG. 5, blue LEDs 52, green LEDs 54 and UV LEDs 56 for multipurpose applications.

In one embodiment of the present invention, the high-performance light source apparatus 30 further comprises a controller 369 electrically coupled to the at least one LED array 361 for controlling on/off of every LED, or on/off of every color of LEDs (blue LEDs 52, green LEDs 54 or UV LEDs 56 shown in FIG. 5). The controller 369 can also control the brightness of the LEDs of the LED array 361 when the LEDs are turned on.

By using a fluorescence photography module 301 and a suitable filter 303, the high-performance light source apparatus 30 can be used for the fluorescence photographing or observation of different biomolecule sample gels 34, such as protein gel, DNA gel, RNA gel and polysaccharide gel, etc.

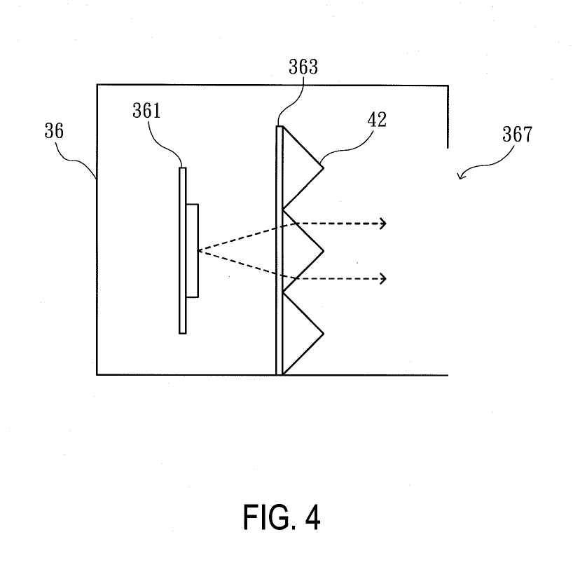

Referring to FIG. 4, the light-emitting module 36 further comprises a first condenser 363 disposed between the LED array 361 and the light-emitting port 367 for condensing or collimating vertically diverging light from the LED array 361 so that the condensed or collimated light can pass through the light-emitting port 367 and be projected onto the lateral of the biomolecule sample gel 34. The first condenser 363 comprises a plurality of horizontal micro-prismatic structures 42 to condense vertically diverging light from the LED array 361.

Referring to FIG. 5, the light-emitting module 36 further comprises a second condenser 365 disposed between the LED array 361 and the light-emitting port 367 for condensing or collimating horizontally diverging light from the LED array 361 so that the condensed or collimated light can pass through the light-emitting port 367 and be projected onto the lateral of the biomolecule sample gel 34. The second condenser 365 comprises a plurality of vertical micro-prismatic structures 58 to condense horizontally diverging light from the LED array 361.

In one embodiment of the present invention, the base frame 32 is a piece of glass having a top surface. The supporting region 323 located on the top surface 321 for supporting the biomolecule sample gel 34. The light-emitting module 36 is disposed around the biomolecule sample gel 34 for projecting the exciting light partially onto the sidewall 341 of the biomolecule sample gel 34. In this embodiment, the light-emitting module 36 is disposed right around the biomolecule sample gel 34 for providing the exciting light directly. Since the biomolecule sample gel 34 is usually thin in thickness, the exciting light can be projected onto the sidewall 341 of the biomolecule sample gel 34 partially, and the rest of the exciting light will be projected to the top of the biomolecule sample gel 34.

In conclusion, the high-performance light source apparatus 30 for fluorescence photography of the present invention enhances energy efficiency, and is practical for multiple applications. Therefore, the invention achieves material saving and high efficiency of material utilization. Furthermore, since the exciting light is projected onto the biomolecule sample gel 34 laterally and one dimensional LED array is sufficient to achieve a satisfactory exciting light illumination, that the size of the high-performance light source apparatus 30 can be minimized, and high mobility and space-saving can be achieved.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A high-performance light source apparatus for fluorescence photography, comprising:
a base frame having a top surface;
a supporting region located on the center area of the top surface for supporting a biomolecule sample gel; and
at least one light-emitting module disposed on the top surface around the border area for projecting an exciting light laterally onto the biomolecule sample gel.

2. The high-performance light source apparatus for fluorescence photography as claimed in claim 1, wherein each light-emitting module comprises:
a light-emitting port located at the side adjacent to the supporting region; and
an LED array having a plurality of LEDs for emitting an exciting light through the light-emitting port onto the biomolecule sample gel.

3. The high-performance light source apparatus for fluorescence photography as claimed in claim 2, wherein each light-emitting module further comprises at least one condenser disposed between the LED array and the light-emitting port for condensing or collimating the exciting light onto the biomolecule sample gel.

4. The high-performance light source apparatus for fluorescence photography as claimed in claim 2, wherein each LED array is a one-dimensional LED array.

5. The high-performance light source apparatus for fluorescence photography as claimed in claim 4, wherein each LED array comprises at least one color of LEDs.

6. The high-performance light source apparatus for fluorescence photography as claimed in claim 5, wherein the at least one color of LEDs are selected from one of blue LEDs, green LEDs, ultraviolet LEDs or the combination thereof.

7. The high-performance light source apparatus for fluorescence photography as claimed in claim 5, further comprising a controller electrically coupled to each LED array for controlling on/off of every color of LEDs.

8. The high-performance light source apparatus for fluorescence photography as claimed in claim 7, wherein the controller is capable of controlling the brightness of the LEDs when the LEDs are turned on.

9. The high-performance light source apparatus for fluorescence photography as claimed in claim 3, wherein each condenser comprises a plurality of micro-prismatic structures.

10. The high-performance light source apparatus for fluorescence photography as claimed in claim 1, wherein the biomolecule sample gel is selected from one of a protein gel, a DNA gel, an RNA gel or a polysaccharide gel.

11. A high-performance light source apparatus for fluorescence photography, comprising:
a base frame having a top surface;
a supporting region located on the top surface for supporting a biomolecule sample gel; and
at least one light-emitting module disposed around the biomolecule sample gel for projecting an exciting light partially onto the sidewall of the biomolecule sample gel.

12. The high-performance light source apparatus for fluorescence photography as claimed in claim 11, wherein each light-emitting module comprises:
a light-emitting port located at the side adjacent to the supporting region; and
an LED array having a plurality of LEDs for emitting an exciting light through the light-emitting port partially onto the sidewall of the biomolecule sample gel.

13. The high-performance light source apparatus for fluorescence photography as claimed in claim 12, wherein each light-emitting module further comprises at least one condenser disposed between the LED array and the light-emitting port for condensing or collimating the exciting light onto the biomolecule sample gel.

14. The high-performance light source apparatus for fluorescence photography as claimed in claim 12, wherein each LED array is a one-dimensional LED array.

15. The high-performance light source apparatus for fluorescence photography as claimed in claim 14, wherein each LED array comprises at least one color of LEDs.

16. The high-performance light source apparatus for fluorescence photography as claimed in claim 15, wherein the at least one color of LEDs are selected from one of blue LEDs, green LEDs, ultraviolet LEDs or the combination thereof.

17. The high-performance light source apparatus for fluorescence photography as claimed in claim 15, further comprising a controller electrically coupled to each LED array for controlling on/off of every color of LEDs.

18. The high-performance light source apparatus for fluorescence photography as claimed in claim 17, wherein the controller is capable of controlling the brightness of the LEDs when the LEDs are turned on.

19. The high-performance light source apparatus for fluorescence photography as claimed in claim 13, wherein each condenser comprises a plurality of micro-prismatic structures.

20. The high-performance light source apparatus for fluorescence photography as claimed in claim 11, wherein the biomolecule sample gel is selected from one of a protein gel, a DNA gel, an RNA gel or a polysaccharide gel.
